(19) United States
(12) Patent Application Publication
(10) Pub. No.: US 2008/0259736 A1
(43) Pub. Date: Oct. 23, 2008

(54) USER INTERFACE FOR TIMER

(76) Inventor: William L. Richter, Jr., Antioch, IL (US)

Correspondence Address: SCHIFF HARDIN, LLP;PATENT DEPARTMENT, 6600 SEARS TOWER, CHICAGO, IL, 60606-6473, US

(21) Appl. No.: 11/737,820

(22) Filed: Apr. 20, 2007

(51) Int. Cl. G04F 8/00

(52) U.S. Cl. 368/107

(57) ABSTRACT

A timer has a dial, a captured tripper, and/or a retainer. The captured tripper has active and inactive positions on the dial. In the inactive position, the captured tripper is captured to the dial but is free to move independently of the dial. Alternatively or additionally, in the inactive position, the captured tripper is not positioned to operate a switch. In the active position, the captured tripper is captured to the dial and is prevented from moving independently of the dial. Alternatively or additionally, in the active position, the captured tripper is positioned to operate the switch. The retainer maintains a predetermined orientation between the captured tripper and the dial when the captured tripper is in both the active and inactive positions.

### TECHNICAL FIELD

The technical field of the present disclosure relates to a user interface for a timer such as an electromechanical timer.

### BACKGROUND

Timer switches, whether mechanical, electrical, or electromechanical, have been used in a wide variety of indoor and outdoor applications. For example, one popular use of such timers is to switch lights on and off. Typical timers permit the on and off times to be independently controlled so that a load, such as the above mentioned lights, is switched on at a first independently set time and is switched off at a later second independently set time.

In order to select desired on and off times, it is known to equip timers with pins or trippers whose positions are individually selectable so to trip one or more switches on and off at the desired times. Unfortunately, these known timers have a number of drawbacks.

For example, if a timer is provided with multiple on pins or trippers and multiple off pins or trippers so that more than one on time and more than one off time may be set, and if a user desires to set only one on time and only one off time, the user must remove from the timer the pins or trippers that are not being used. Not only is the removal of these excess pins or trippers an unnecessary nuisance, but these removed pins or trippers can be mislaid so that they are not readily available should the user later desire to set additional on and off times.

Furthermore, the pins or trippers of known timers must be removed from and reattached to the timer whenever a user chooses to adjust the on and off times. Pins or trippers can be dropped during their removal and reattachment, which at a minimum is a nuisance. Worse, dropped pins or trippers can be lost, especially when timers are used outdoors.

The timer described below overcomes one or more of these or other problems.

### BRIEF DESCRIPTION OF THE DRAWINGS

Features and advantages of the timer described herein will become apparent from the detailed description below when taken in conjunction with the drawings in which:

FIG. 1 is an exploded view of the timer described below;

FIG. 2 is a front view of a relevant portion of the timer of FIG. 1;

FIG. 3 is a cross-section of the timer of FIG. 1 taken along section lines 3-3 of FIG. 2;

FIG. 4 shows a portion of the timer of FIGS. 1-3; and,

FIGS. 5-7 illustrate a cam and switch arrangement that can be used in connection with the timer of FIGS. 1-5.

### DETAILED DESCRIPTION

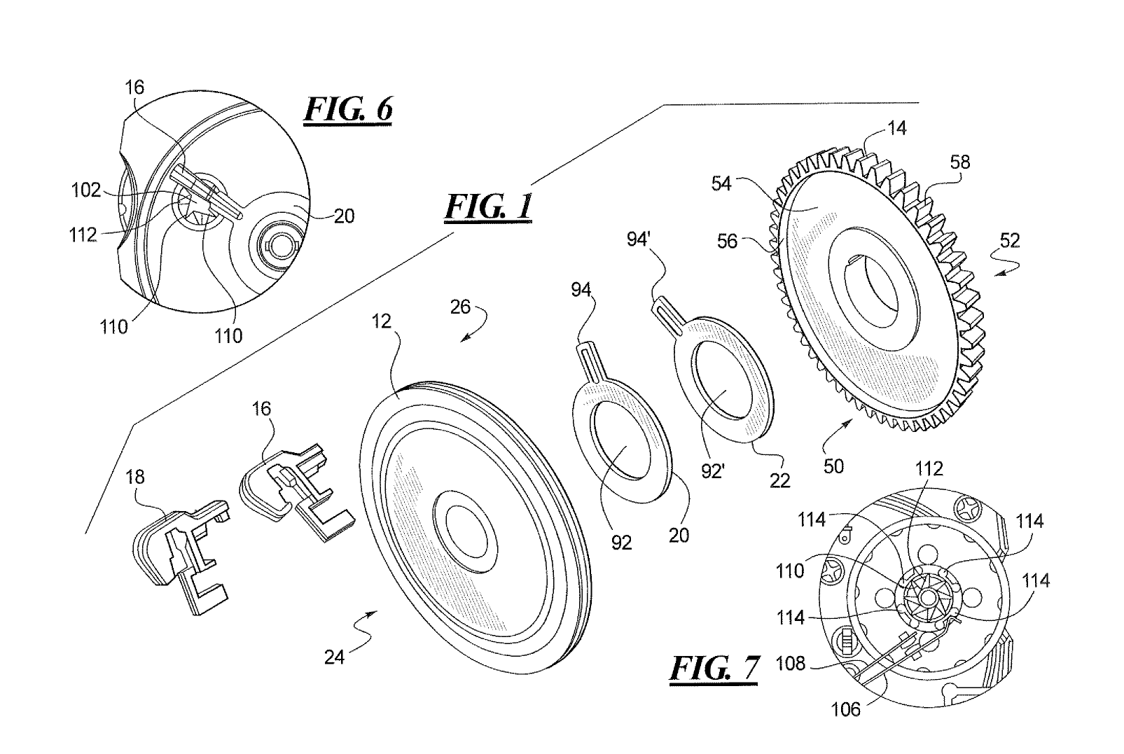

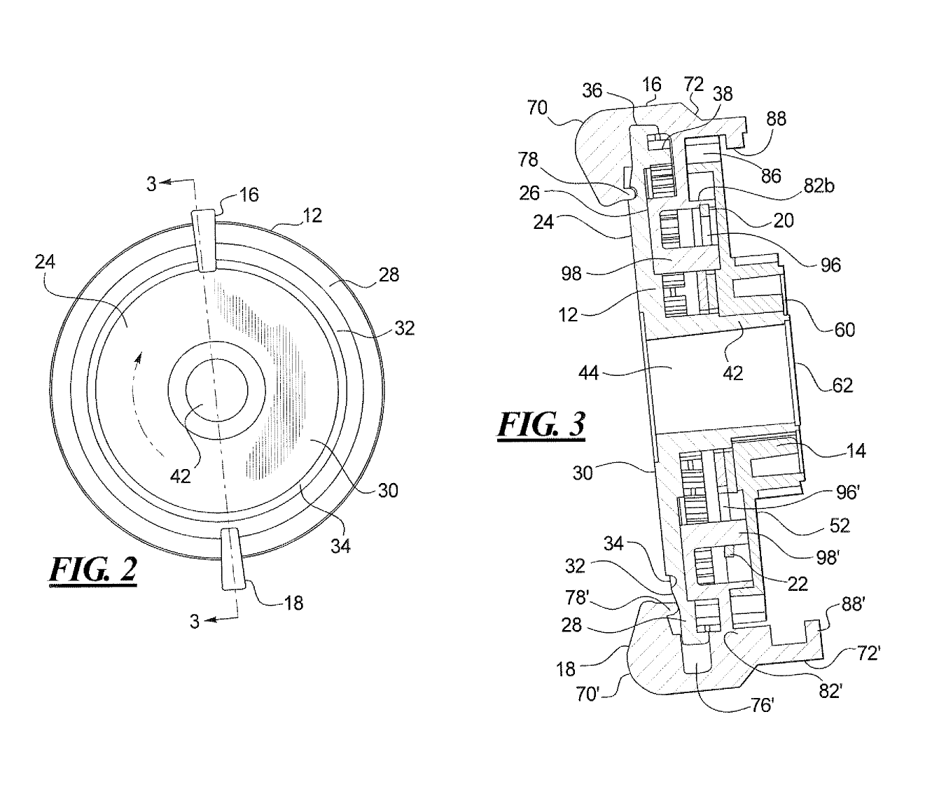

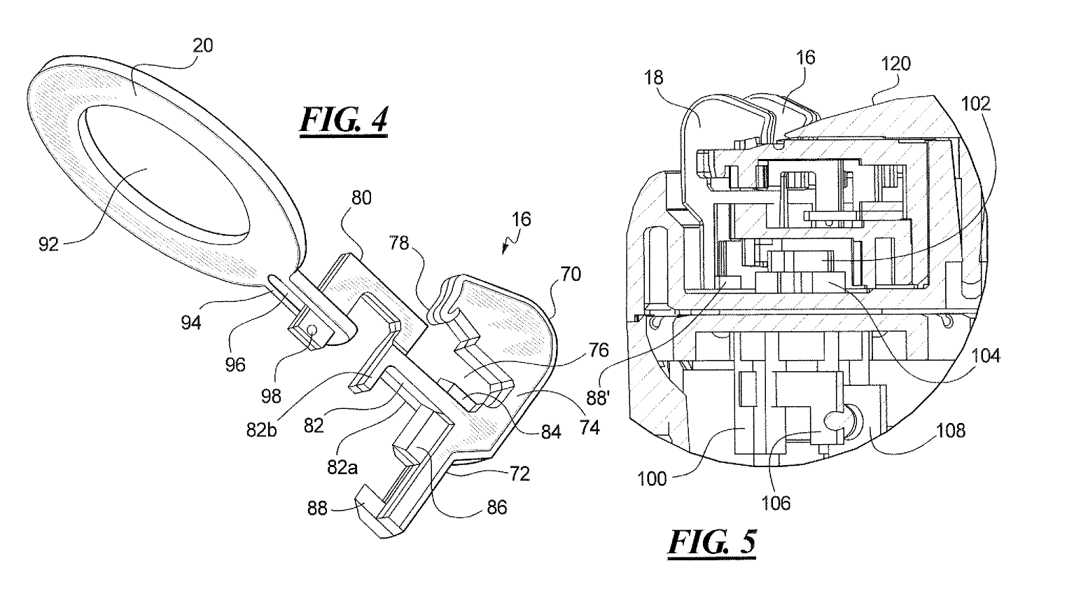

A timer 10 as shown in FIGS. 1-5 includes first and second dials 12 and 14, first and second captured trippers 16 and 18, and first and second retainers 20 and 22. The first and second dials 12 and 14 may be keyed together so that a timer movement moves the first and second dials 12 and 14 in unison. The movement of the timer 10 may be a mechanical, electrical, or electromechanical movement that is arranged to rotate the first and second dials 12 and 14 in the direction of the arrow shown in FIG. 2.

The first dial 12 has first and second sides 24 and 26. The first side 24 includes an annular outer ring 28, an annular inner ring 30, an annular ramp shaped ring 32, and an annular groove 34. The annular outer ring 28 and the annular inner ring 30 are disposed in planes that are parallel to and offset from one another. The annular ramp shaped ring 32 is between the annular outer ring 28 and the annular groove 34. The annular groove 34 is between the annular ramp shaped ring 32 and the annular inner ring 30.

The first dial 12 has an annular peripheral edge 36 extending between the first and second sides 24 and 26 and that overhangs the second side 26 by a small amount. Teeth 38 are disposed annularly around the second side 26 near the annular peripheral edge 36. The first dial 12 also has a hub 42 and a central hole 44 extending through the hub 42.

The second dial 14 has first and second sides 50 and 52. The first side 50 of the second dial 14 faces the second side 26 of the first dial 12 when the timer 10 is assembled. The first side 50 is formed with an annular well 54 surrounded by an annular rim 56 at the peripheral edge of the second dial 14. Teeth 58 are provided around the outer perimeter of the annular rim 56. The second dial 14 also has a hub 60 and a hole 62 through the hub 60. The hole 62 of the second dial 14 aligns with the hole 42 of the first dial 12 when the timer 10 is assembled as shown in FIG. 3.

The first captured tripper 16 is formed as an on tripper since it cooperates with a first cam portion to close a pair of switch contacts, and the second captured tripper 18 is formed as an off tripper since it cooperates with a second cam portion to open the pair of switch contacts.

The first captured tripper 16 has a head 70 joined to a barrel 72 by a neck 74. A recess 76 is formed at the neck 74 between the head 70 and the barrel 72. The end of the head 70 is formed with a protrusion 78 that engages the annular groove 34 when the first captured tripper 16 is in its active position. A horseshoe shaped bracket 80 is attached to an arm 82 that depends from the barrel 72 near the neck 74 of the first captured tripper 16. The arm 82 is L-shaped having first and second arm portions 82a and 82b. The first arm portion 82a is formed at a right angle to the barrel 72, and the second arm portion 82b is formed at a right angle to the first arm portion 82a so that the second arm portion 82b is parallel to the barrel 72.

The first captured tripper 16 further includes a first tooth 84 attached to the barrel 72 on one side of the arm 82, a second tooth 86 attached to the barrel 72 on the opposite side of the arm 82, and a switch operator 88 at the end of the barrel 72. The first tooth 84 meshes with the teeth 38 of the first dial 12 when the first captured tripper 16 is in its active position, the second tooth 86 meshes with the teeth 58 of the second dial 14 when the first captured tripper 16 is in its active position, and the switch operator 88 cooperates with the first cam portion to close the switch contacts when the first captured tripper 16 is in its active position and the first and second dials 12 and 14 are rotated sufficiently for the switch operator 88 to engage an appropriate lobe on the first cam portion.

The first retainer 20 has a hole 92 that aligns with the hole 42 of the first dial 12 and the hole 62 of the second dial 14 when the timer 10 is assembled as shown in FIG. 3. A tab 94 extends from the outer periphery of the first retainer 20 away from the hole 92. The tab 94 has a slot 96 that receives an arm 98 of the bracket 80 of the first captured tripper 16 and that permits the first captured tripper 16 to move between its active and inactive positions.

The first captured tripper 16 is captured to the timer 10 when the first and second dials 12 and 14 are mated as shown in FIG. 3. The horseshoe shaped bracket 80 and the second arm portion 82b ensure that the first captured tripper 16 is captured to the timer 10 when the first and second dials 12 and 14 are mated so that the first captured tripper cannot become separated from the timer 10, even when the first captured tripper 16 is in its inactive position.

The second captured tripper 18 is formed similarly to the first captured tripper 16, differing only in that the barrel 721 of the second captured tripper 18 is longer than the barrel 72 of the first captured tripper 16. Therefore, the switch operator 88 of the first captured tripper 16 but not the switch operator 88′ of the second captured tripper 18 cooperates with the first cam portion to close the switch contacts, and the switch operator 88′ of the second captured tripper 15 but not the switch operator 88 of the first captured tripper 16 cooperates with the second cam portion to open the switch contacts.

During assembly, the second captured tripper 18 is snapped onto the first dial 12 so that its protrusion 78′ is against the annular ramp shaped ring 32, so that its recess 76′ receives the annular edge 36 of the first dial 12, and so that its arm 82′ snugly engages the second side 26 of the first dial 12. This position of the second captured tripper 18 is the inactive position. The second retainer 22 is then inserted onto the first dial 12 so that its hole 92′ receives the hub 42 of the first dial 12 and so that its slot 96′ receives the arm 98′ of the bracket 80′ of the second captured tripper 18.

The first captured tripper 16 and the first retainer 20 are similarly applied to the first dial 12.

The second dial 14 is then applied to the first dial 12 so that the hub 42 of the first dial 12 is received within the hub 60 of the second dial 14. The first and second dials 12 and 14 are keyed together so that the teeth 38 of the first dial 12 are aligned with the teeth 58 of the second dial 14. For example, the inside perimeter of the hub 60 of the second dial 14 may have a ridge, and the outside perimeter of the hub 42 of the first dial 12 may have a slot. The ridge and slot extend along an axis that is parallel to the center axis of the holes 44 and 62. Accordingly, when the second dial 14 is applied to the first dial 12 so that the hub 42 of the first dial 12 is received within the hub 60 of the second dial 14, the ridge slides into and mates with the slot.

FIG. 3 shows the first captured tripper 16 in its active position and the second captured tripper 18 in its inactive position. When the first captured tripper 16 is in its active position, its protrusion 78 is received in the annular groove 34 of the first dial 12, its first tooth 84 meshes with the teeth 38 of the first dial 12, and its second tooth 86 meshes with the teeth 58 of the second dial 14.

Because the protrusion 78 of the first captured tripper 16 is engaged within the annular groove 34 of the first dial 12, because the first tooth 84 of the first captured tripper 16 meshes with the teeth 38 of the first dial 12, because the second tooth 86 of the first captured tripper 16 meshes with the teeth 58 of the second dial 14, and because the first and second dials 12 and 14 are keyed together and thereby cannot rotate independently of one another, the first captured tripper 16 is locked into position on the first dial 12 and cannot rotate independently of the first dial 12. In its active position, the first captured tripper 16 is in position to close the switch when the first and second dials 12 rotate sufficiently that the switch operator 88 engages the first cam portion.

To move the first captured tripper 16 to its active position on the first dial 12, the user simply pushes the first captured tripper 16 in a direction perpendicularly toward the hubs 42 and 60. Doing so causes the protrusion 78 of the first captured tripper 16 to ride along the annular ramp shaped ring 32 and engage the annular groove 34 of the first dial 12, causes the first tooth 84 of the first captured tripper 16 to mesh with the teeth 38 of the first dial 12, and causes the second tooth 86 of the first captured tripper 16 to mesh with the teeth 58 of the second dial 14. The first captured tripper 16 would then have the active position with respect to the first dial 12 exemplified by the position of the first captured tripper 16 as shown in FIG. 3.

To move the first captured tripper 16 to its inactive position on the first dial 12, the user simply pulls the first captured tripper 16 in a direction perpendicularly away from the hubs 42 and 60. Doing so causes the protrusion 78 of the first captured tripper 16 to disengage from the annular groove 34 of the first dial 12 and ride along the annular ramp shaped ring 32, causes the first tooth 84 of the first captured tripper 16 to move out of the teeth 38 of the first dial 12, and causes the second tooth 86 of the first captured tripper 16 to move out of the teeth 58 of the second dial 14. The first captured tripper 16 would then have the inactive position with respect to the first dial 12 exemplified by the position of the second captured tripper 18 as shown in FIG. 3.

Because the first and second teeth 84 and 86 no longer mesh with the teeth 38 and 58, the first captured tripper 16 is free to move around the periphery of the first dial 12 even though the first dial 12 is stationary. As the first captured tripper 16 moves around the periphery of the first dial 12, the retainer 20 rotates about the hubs 42 and 60. Thus, the first captured tripper 16 may be moved to a new position relative to the first dial 12. Moreover, even though the first captured tripper 16 is free to move around the periphery of the first dial 12, the first captured tripper 16 is still captured to the timer 10 as discussed above. Furthermore, when the first captured tripper 16 is in its inactive position, the first captured tripper 16 is not in position to engage the first cam portion.

Accordingly, the first and second captured trippers 16 and 18 when not in their active positions are allowed to move freely relative to the first dial 12 and yet are captured to the timer 10 as explained above so that the first and second captured trippers 16 and 18 cannot be separated from the timer 10 without disassembling the timer 10. Therefore, the first and second captured trippers 16 and 18 when not in use to control the switch cannot be accidentally lost from the timer 10.

The retainers 20 and 22 rotate about the hubs 42 and 60 as their corresponding first and second captured trippers 16 and 18 move about the first dial 12. At the same time, the retainers 20 and 22 maintain the orientation of the first and second captured trippers 16 and 18 on the first dial 12 so that the first and second teeth 84 can properly mate with the corresponding teeth 38 and 58 on the first and second dials 12 and 14. Thus, the retainers 16 and 18 insure that the axes along the length of the heads 70 and 70′ of the respective retainers 16 and 18 as viewed in FIG. 2 always intersect the center axis of the hole 42. In this manner, the retainers 16 and 18 prevent the first and second captured trippers 16 and 18 from becoming canted on the first dial 12 so that the teeth 84 and 86 are improperly oriented with respect to the corresponding teeth 38 and 58.

The timer 10 can be easily provided with more than two captured trippers. In this case, a retainer is added for each of the additional captured trippers. If the user desires to use only one pair of on and off captured trippers to operate the switch so as to control a load, the user simply moves the unused on and off captured trippers to the inactive position shown by the position of the second captured tripper 18 in FIG. 3. For example, if the timer 10 is provided with two on captured trippers and two off captured trippers, and if the user desires to use only one pair of on and off captured trippers to operate the switch so as to control a load, the user moves one on captured tripper and one off captured tripper to the active position shown by the position of the first captured tripper 16 in FIG. 3, and moves the unused on captured tripper and the unused off captured tripper to the inactive position shown by the position of the second captured tripper 18 in FIG. 3.

As shown in FIGS. 5, 6, and 7, a cam 100 has first and second cam portions 102 and 104 at one end thereof. The first and second cam portions 102 and 104 rotate in unison under action of the first and second captured trippers 16 and 18 to control the position of a movable switch blade 106 with respect to a stationary switch blade 108. As shown by the top view of FIG. 6 (with the first and second dials 12 and 14 removed for clarity) and the bottom view of FIG. 7, the first cam portion 102 has lobes 110, and the second cam portion 104 has lobes 112.

When the first dial 12 has sufficiently rotated, and with the captured tripper 16 in its active position, the switch operator 88 of the captured tripper 16 moves into contact with the lobes 110 and rotates the first and second cam portions 102 and 104 and the cam 100. similarly, when the first dial 12 has sufficiently rotated, and with the captured tripper 18 in its active position, the switch operator 88′ of the captured tripper 18 moves into contact with the lobes 112 and rotates the first and second cam portions 102 and 104 and the cam 100.

As shown in FIG. 7, rotation of the cam 100 moves the switch blade 106. Specifically, the end of the cam 100 opposite to first and second cam portions 102 and 104 has four switch controllers 114, although a different number of switch controllers may be used. FIG. 7 illustrates the position of the cam 100 and switch controllers 114 when the first captured tripper 16 has rotated the cam 100 to the switch on position. In the switch on position, the movable switch blade 106 is allowed to fall into the gap between two adjacent switch controllers 114 so that the movable switch blade 106 engages the stationary switch blade 108. When the cam 100 is next rotated by the second captured tripper 18, the cam 100 assumes the switch off position. In the switch off position, the movable switch blade 106 rides up on one of the switch controllers 114 so that the movable switch blade 106 disengages from the stationary switch blade 108.

Certain modifications of the timer 10 have been discussed above. Other modifications of the timer 10 will occur to those practicing in the art of the timer 10. For example, as described above, the first captured tripper 16 drives the switch contacts 106 and 108 to their closed position, and the second captured tripper 18 drives the switch contacts 106 and 108 to their open position. Alternatively, the first captured tripper 16 may be arranged to drive the switch contacts 106 and 108 to their open position, and the second captured tripper 18 may be arranged to drive the switch contacts 106 and 108 to their closed position.

Moreover, the timer 10 may be provided with a cover 120 (FIG. 5) that provides hour or actual time marks so that the first and second captured trippers 16 and 1 may be positioned on the first dial 12 relative to one another based on time.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

I claim:

1. A timer comprising:
a dial;
a captured tripper having first and second positions on the dial such that, in the first position, the captured tripper is free to move independently of the dial and such that, in the second position, the captured tripper is prevented from moving independently of the dial, wherein the captured tripper is configured to be captured to the dial in both the first and second positions; and,
a retainer, wherein the retainer maintains a predetermined orientation of the captured tripper on the dial in the first and second positions.

2. The timer of claim 1 further comprising a switch, wherein the switch is operated by the captured tripper when the captured tripper is in the second position, and wherein the switch is not operated by the captured tripper when the captured tripper is in the first position.

3. The timer of claim 1 wherein the dial includes a hub, wherein the retainer includes a hole, wherein the hole receives the hub, wherein the retainer further includes a tab having a slot, and wherein the slot receives a member of the captured tripper.

4. The timer of claim 1 wherein the dial includes teeth, wherein the captured tripper includes at least one tooth, wherein the tooth of the captured tripper meshes with the teeth of the dial when the captured tripper is in the second position so as to prevent the captured tripper from moving independently of the dial, and wherein the tooth of the captured tripper does not mesh with the teeth of the dial when the captured tripper is in the first position so that the captured tripper is permitted to move independently of the dial.

5. The timer of claim 1 wherein the dial comprises a first side, a second side, and a peripheral rim, wherein the first side includes a groove, wherein the captured tripper comprises a protrusion that engages the groove when the captured tripper is in the second position, and wherein the protrusion does not engage the groove when the captured tripper is in the first position.

6. The timer of claim 1 wherein the dial comprises a first side, a second side, and a peripheral rim, wherein the first side includes a groove, wherein the captured tripper comprises a first portion, a second portion, a neck, an arm, and a recess, wherein the neck joins the first and second portions, wherein the recess is between the first and second portions, wherein the first portion comprises a protrusion that engages the groove when the captured tripper is in the second position, wherein the protrusion does not engage the groove when the captured tripper is in the first position, wherein the recess receives rim when the captured tripper is in the second position, and wherein the arm engages the second side when the captured tripper is in the second position.

7. The timer of claim 1 wherein the dial comprises a first dial, wherein the timer comprises a second dial, wherein the first and second dials are arranged to move in unison, wherein the first dial includes teeth, wherein the second dial includes teeth, wherein the captured tripper includes first and second teeth, wherein the first tooth of the captured tripper meshes with the teeth of the first dial when the captured tripper is in the second position to prevent the captured tripper from moving independently of the first dial, wherein the second tooth of the captured tripper meshes with the teeth of the second dial when the captured tripper is in the second position to prevent the captured tripper from moving independently of the first dial, wherein the first tooth of the captured tripper does not mesh with the teeth of the first dial when the captured tripper is in the first position so that the captured tripper is permitted to move independently of the first dial, and wherein the second tooth of the captured tripper does not mesh with the teeth of the second dial when the captured tripper is in the first position so that the captured tripper is permitted to move independently of the first dial.

8. The timer of claim 7 wherein the first dial comprises a first side, a second side, and a peripheral rim, wherein the first side includes a groove, wherein the captured tripper comprises a first portion, a second portion, a neck, an arm, and a recess, wherein the neck joins the first and second portions, wherein the recess is between the first and second portions, wherein the first portion comprises a protrusion that engages the groove when the captured tripper is in the second position, wherein the protrusion does not engage the groove when the captured tripper is in the first position, wherein the recess receives rim when the captured tripper is in the second position, and wherein the arm engages the second side when the captured tripper is in the second position.

9. The timer of claim 7 wherein retainer is sandwiched between the first and second dials.

10. The timer of claim 1 wherein the dial comprises a first dial, wherein the timer comprises a second dial, wherein the second dial includes teeth, wherein the captured tripper includes a tooth, wherein the tooth of the captured tripper meshes with the teeth of the second dial when the captured tripper is in the second position to prevent the captured tripper from moving independently of the first dial, and wherein the tooth of the captured tripper does not mesh with the teeth of the second dial when the captured tripper is in the first position so that the captured tripper is permitted to move independently of the first dial.

11. A timer comprising:
a first dial;
a second dial mated to the first dial; and,
a captured tripper having active and inactive positions on the first dial such that, in the active position, the captured tripper is positioned to operate a switch and such that, in the inactive position, the captured tripper is not positioned to operate the switch, wherein the captured tripper has first and second tripper portions, wherein the first tripper portion is exterior of the first and second dials and permits a user to move the captured tripper between the active and inactive positions, and wherein the second tripper portion is interior of the first and second dials so as to capture the captured tripper to the first and second dials in both the active and inactive positions.

12. The timer of claim 11 further comprising a retainer, wherein the retainer maintains a predetermined orientation of the captured tripper on the first dial in both the active and inactive positions, wherein at least one of the first and dials includes a hub, wherein the retainer includes a hole, wherein the hole receives the hub, wherein the retainer further includes a tab having a slot, and wherein the slot receives a member of the captured tripper when the captured tripper is in both of the active and inactive positions.

13. The timer of claim 12 wherein retainer is sandwiched between the first and second dials.

14. The timer of claim 11 wherein the first dial comprises a first side, a second side, and a peripheral rim, wherein the first side includes a groove, wherein the captured tripper comprises a protrusion that engages the groove when the captured tripper is in the active position, and wherein the protrusion does not engage the groove when the captured tripper is in the inactive position.

15. The timer of claim 11 wherein the first dial comprises a first side, a second side, and a peripheral rim, wherein the first side includes a groove, wherein the captured tripper comprises a first portion, a second portion, a neck, an arm, and a recess, wherein the neck joins the first and second portions, wherein the recess is between the first and second portions, wherein the first portion comprises a protrusion that engages the groove when the captured tripper is in the active position, wherein the protrusion does not engage the groove when the captured tripper is in the inactive position, wherein the recess receives rim when the captured tripper is in the active position, and wherein the arm engages the second side when the captured tripper is in the active position.

16. A timer comprising:
a dial; and,
a captured tripper having active and inactive positions on the dial such that, in the inactive position, the captured tripper is free to move independently of the dial and the captured tripper is not positioned to operate a switch and such that, in the active position, the captured tripper is prevented from moving independently of the dial and the captured tripper is positioned to operate the switch, wherein the captured tripper has first and second portions, wherein the first portion facilitates movement of the captured tripper between the active and inactive positions, and wherein the second portion prevents the captured tripper from being separated from the dial in both the active and inactive positions.

17. The timer of claim 18 further comprising a retainer, wherein the retainer maintains a predetermined orientation of the captured tripper on the dial in the first and second positions.

18. The timer of claim 17 wherein the dial includes a hub, wherein the retainer includes a hole, wherein the hole receives the hub, wherein the retainer further includes a tab having a slot, and wherein the slot receives a member of the captured tripper so as to maintain orientation of the captured tripper on the dial.

19. The timer of claim 17 wherein the dial comprises a first dial, and wherein the retainer is sandwiched between the first dial and a second dial.

20. The timer of claim 16 wherein the dial includes teeth, wherein the captured tripper includes at least one tooth, wherein the tooth of the captured tripper meshes with the teeth of the dial when the captured tripper is in the active position so as to prevent the captured tripper from moving independently of the dial, and wherein the tooth of the captured tripper does not mesh with the teeth of the dial when the captured tripper is in the inactive position so that the captured tripper is permitted to move independently of the dial.

21. The timer of claim 16 wherein the dial comprises a first side, a second side, and a peripheral rim, wherein the first side includes a groove, wherein the captured tripper comprises a protrusion that engages the groove when the captured tripper is in the active position, and wherein the protrusion does not engage the groove when the captured tripper is in the active position.

22. The timer of claim 16 wherein the dial comprises a first side, a second side, and a peripheral rim, wherein the first side includes a groove, wherein the captured tripper comprises a first portion, a second portion, a neck, an arm, and a recess, wherein the neck joins the first and second portions, wherein the recess is between the first and second portions, wherein the first portion comprises a protrusion that engages the groove when the captured tripper is in the active position, wherein the protrusion does not engage the groove when the captured tripper is in the inactive position, wherein the recess receives rim when the captured tripper is in the active position, and wherein the arm engages the second side when the captured tripper is in the active position.

23. The timer of claim 16 wherein the dial comprises a first dial, wherein the timer comprises a second dial, wherein the first and second dials are arranged to move in unison, wherein the second dial includes teeth, wherein the captured tripper includes a tooth, wherein the tooth of the captured tripper meshes with the teeth of the second dial when the captured tripper is in the active position to prevent the captured tripper from moving independently of the first dial, and wherein the tooth of the captured tripper does not mesh with the teeth of the second dial when the captured tripper is in the inactive position so that the captured tripper is permitted to move independently of the first dial.

24. The timer of claim 16 wherein the dial comprises a first dial, wherein the timer comprises a second dial, wherein the first and second dials are arranged to move in unison, wherein the first dial includes teeth, wherein the second dial includes teeth, wherein the captured tripper includes first and second teeth, wherein the first tooth of the captured tripper meshes with the teeth of the first dial when the captured tripper is in the active position to prevent the captured tripper from moving independently of the first dial, wherein the second tooth of the captured tripper meshes with the teeth of the second dial when the captured tripper is in the active position to prevent the captured tripper from moving independently of the first dial, wherein the first tooth of the captured tripper does not mesh with the teeth of the first dial when the captured tripper is in the inactive position so that the captured tripper is permitted to move independently of the first dial, and wherein the second tooth of the captured tripper does not mesh with the teeth of the second dial when the captured tripper is in the inactive position so that the captured tripper is permitted to move independently of the first dial.

25. The timer of claim 24 wherein the first dial comprises a first side, a second side, and a peripheral rim, wherein the first side includes a groove, wherein the captured tripper comprises a first portion, a second portion, a neck, an arm, and a recess, wherein the neck joins the first and second portions, wherein the recess is between the first and second portions, wherein the first portion comprises a protrusion that engages the groove when the captured tripper is in the active position, wherein the protrusion does not engage the groove when the captured tripper is in the inactive position, wherein the recess receives rim when the captured tripper is in the active position, and wherein the arm engages the second side when the captured tripper is in the active position.
